(19) United States
(12) Patent Application Publication
(10) Pub. No.: US 2022/0290725 A1
(43) Pub. Date: Sep. 15, 2022

(54) POSITIVE OVERRUNNING CLUTCH

(71) Applicant: Hilti Aktiengesellschaft, Schaan (LI)

(72) Inventor: Maximilian KNYRIM, Ehingen (DE)

(21) Appl. No.: 17/633,397

(22) PCT Filed: Aug. 18, 2020
(86) PCT No.: PCT/EP2020/073070

§ 371 Date: Feb. 7, 2022

(30) Foreign Application Priority Data
Aug. 27, 2019 (EP) 19193854.7

(51) Int. Cl. F16D 41/12; B25D 16/00

(52) U.S. Cl. CPC F16D 41/12; B25D 16/003

(57) ABSTRACT

Positive overrunning clutch with an outer ring having a detent contour and an inner ring arranged concentrically in relation to the outer ring, the inner ring having a pawl, which is provided for engagement in the detent contour, the pawl being movably connected to the inner ring and preferably formed in one piece with the inner ring.

The present invention relates to a positive overrunning clutch with an outer ring having a detent contour and an inner ring arranged concentrically in relation to the outer ring. The inner ring has at least one pawl, which is provided for engagement in the detent contour.

### BACKGROUND

Such an overrunning clutch is known for example from DE10 2008 064 153 A1.

### SUMMARY OF THE INVENTION

It is an object of the present invention to provide an overrunning clutch that promotes comparatively simple assembly.

The present invention provides that the pawl is being movably connected to the inner ring and preferably formed in one piece with the inner ring. The invention includes the finding that positive overrunning clutches—for instance in contrast to non-positive overrunning clutches—can be produced with a comparatively small number of parts, which promotes simple and inexpensive assembly. Due to the avoidable “slipping” of positive overrunning clutches, they are particularly suitable for transmitting comparatively high torques, which occur for example in hammer drills. If, as provided in a particularly preferred embodiment, the pawl is formed in one piece (monolithic) with the inner ring, there is a further advantage in terms of simple and inexpensive assembly.

In a particularly preferred design, the inner ring has a secondary pawl which, with respect to an axis of rotation of the overrunning clutch, is arranged on the inner ring offset in the axial direction relative to the pawl. It has been found to be advantageous if the secondary pawl is formed in one piece with the inner ring. In a further preferred design, the pawl and the secondary pawl are spaced apart from one another by a peripheral axial gap. The pawl and the secondary pawl may be in line in the axial direction.

It has been found to be particularly advantageous if the pawl and/or the secondary pawl is formed in each case as a pressure pawl.

In a further preferred design, the inner ring has a plurality of pawls, which are arranged along an outer circumference of the inner ring. The inner ring may have a plurality of secondary pawls, which are arranged along an outer circumference of the inner ring. It is particularly preferred if the pawl and the secondary pawl are in line in the axial direction.

It has been found to be advantageous if the outer ring and/or the inner ring is provided as an injection-molded part. The outer ring and/or the inner ring may consist of plastic or comprise such a plastic. Particularly preferably, the outer ring and/or the inner ring is formed metal-free. A pawl and/or a secondary pawl may have a number of engagement flanks for engagement in a detent contour.

In a further preferred design, the inner ring has a reinforcing profile to increase a transmittable torque. The reinforcing profile is preferably supported against a counter profile formed on the pawl when the overrunning clutch is actuated in the blocking direction, The blocking direction is preferably based on actuation on the outer ring. It has been found to be advantageous if the reinforcing profile and/or the counter profile is arranged on a side of the pawl that is facing away from the detent contour. The reinforcing profile and/or the counter profile may be formed in one piece with the inner ring.

In a particularly preferred design, the overrunning clutch has a secondary outer ring arranged concentrically in relation to the inner ring. The secondary outer ring is preferably formed as a part different from the outer ring. A freewheeling function independent of the outer ring can thus be advantageously obtained by means of the secondary outer ring. The outer ring and the secondary outer ring may be arranged on one and the same inner ring. The design of the overrunning clutch with a secondary outer ring arranged concentrically in relation to the inner ring can be used both for a pawl and/or secondary pawl formed in one piece with the inner ring and for a pawl and/or secondary pawl not formed in one piece with the inner ring.

It has been found to be advantageous if the outer ring has a swivel sleeve for coupling the outer ring to an impact mechanism and/or a rotary drive of a hammer drill.

A hammer drill that has an overrunning clutch of the type described above is also provided. The tool fitting of the hammer drill is preferably coupled to the impact mechanism and/or the rotary drive for the purpose of transferring movement. The tool fitting may be designed for receiving a striking and rotating tool.

Further advantages can be found in the following description of the figures. Various exemplary embodiments of the present invention are shown in the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs. In the figures:

FIG. 1 shows a first preferred exemplary embodiment of an overrunning clutch;

FIG. 2 shows a second preferred exemplary embodiment of an overrunning clutch;

FIG. 3 shows a third preferred exemplary embodiment of an overrunning clutch; and

FIGS. 4a and 4b show a fourth preferred exemplary embodiment of an overrunning clutch.

### DETAILED DESCRIPTION

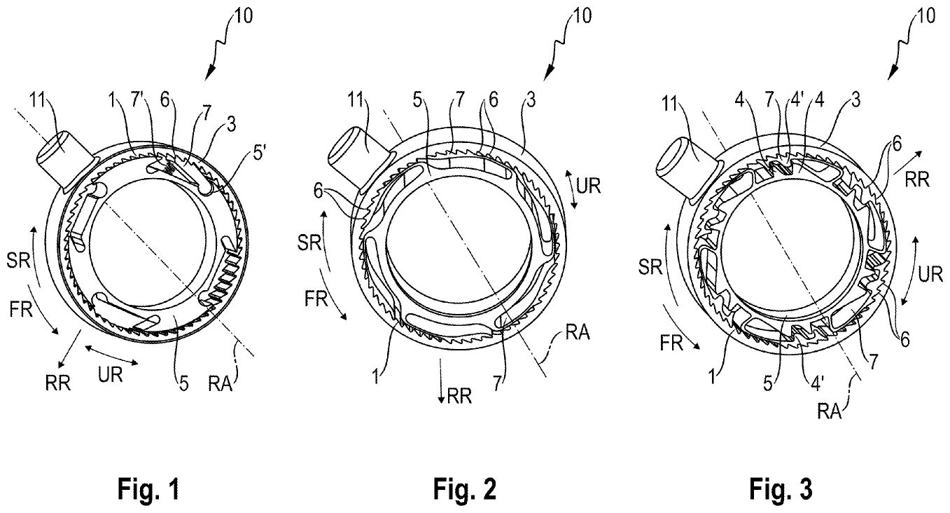

A first exemplary embodiment of a positive overrunning clutch 10 according to the invention is shown in FIG. 1. The positive overrunning clutch 10 is equipped with an outer ring 3 having a detent contour 1 and an inner ring 5 arranged concentrically in relation to the outer ring 3. The inner ring 5 has a pawl 7, which is provided for engagement in the detent contour 1. The pawl 7 is movably connected to the inner ring 5 in the radial direction RR. The pawl 7 is formed as a discrete part, i.e. in particular not formed in one piece with the inner ring 5.

The discretely formed pawl 7 has been introduced into a pawl groove 5′ provided in the inner ring 5 (for example by being pushed in parallel to the axis of rotation RA) and is thus movably connected to the inner ring 5 The pawl 7 is formed as a pressure pawl. A compression spring 7′ biases the pawl 7 in a radial direction RR of the detent contour 1.

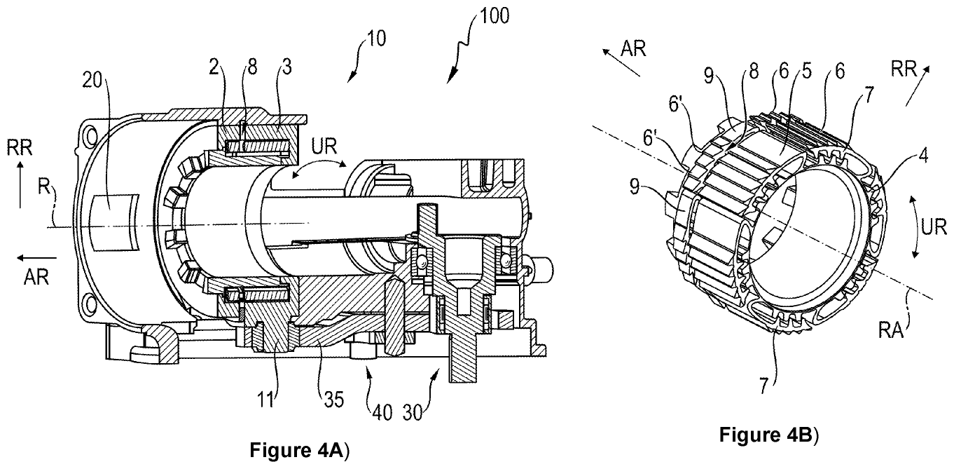

The outer ring 3 has a swivel sleeve 11, by way of which the outer ring 3 can be coupled for example to an impact mechanism 30 and/or a rotary drive 40 of a hammer drill 100 (cf. FIGS. 4a and 4b).

If the overrunning clutch 10 is actuated on the outer ring 3 in the blocking direction SR, for example by means of the swivel sleeve 11, torque transmission to the inner ring 5 is possible. One tip 6 of the pawl 7 is thereby pressed against the detent contour 1 in the manner of a pressure pawl. If the overrunning clutch 10 is actuated on the outer ring 3 in the freewheeling direction FR, for example by means of the swivel sleeve 11, the outer ring 3 can spin. Apart from a negligible detachment torque of the pawl 7, no torque is transmitted to the inner ring 5.

As can be seen from FIG. 1, four pawl grooves 5′ may be provided in the circumferential direction UR, so that a total of four pawls 7 can be received in the inner ring 5, which are then arranged on an outer circumference of the inner ring 5. In the exemplary embodiment of FIG. 1, by way of example the outer ring 3 and the pawls 7 are made from metal. The inner ring 5 is a comparatively inexpensive injection-molded part and consists of plastic.

A second exemplary embodiment of a positive overrunning clutch 10 according to the invention is shown in FIG. 2. The positive overrunning clutch 10 is equipped with an outer ring 3 having a detent contour 1 and an inner ring 5 arranged concentrically in relation to the outer ring 3. The inner ring 5 has a pawl 7, which is provided for engagement in the detent contour 1. The pawl 7 is movably connected to the inner ring 5 in the radial direction RR.

As can be seen from FIG. 2, the pawl 7 is formed in one piece with the inner ring 5. More precisely, the inner ring 5 has six pawls 7, which are arranged along an outer circumference UR of the inner ring 5. All of the pawls 7 are formed in one piece with the inner ring 5. Each of the pawls 7 has a number of engagement flanks 6, which allows a higher torque transmission to the inner ring 5, which is provided here by way of example as a plastic injection-molded part. By way of example, the outer ring 3 together with the swivel sleeve 11 is made of metal. The freewheeling mechanism 10 of FIG. 2 consists by way of example of exactly two parts, specifically the one-piece inner ring 5 and the one-piece outer ring 3.

A third exemplary embodiment of a positive overrunning clutch 10 according to the invention is shown in FIG. 3. The positive overrunning clutch 10 is equipped with an outer ring 3 having a detent contour 1 and an inner ring 5 arranged concentrically in relation to the outer ring 3. The inner ring 5 has a pawl 7, which is provided for engagement in the detent contour 1. The pawl 7 is movably connected to the inner ring 5 in the radial direction RR.

As can be seen from FIG. 3, the pawl 7 is formed in one piece with the inner ring 5. More precisely, the inner ring 5 has six pawls 7, which are arranged along an outer circumference UR of the inner ring 5. All of the pawls 7 are formed in one piece with the inner ring 5. Each of the pawls 7 has a number of engagement flanks 6, which allows a higher torque transmission to the inner ring 5, which is provided here by way of example as a plastic injection-molded part. By way of example, the outer ring 3 together with the swivel sleeve 11 is made of metal.

To increase a torque that can be transmitted in the blocking direction SR, the inner ring 5 has a reinforcing profile 4. The reinforcing profile 4 is supported against a counter profile 4′ formed on the pawl 7 when the overrunning clutch 10 is actuated in the blocking direction SR. Both the reinforcing profile 4 and the counter profile 4′ are arranged on a side of the pawl 7 that is facing away from the detent contour 1. In the exemplary embodiment shown here, for each pawl 7 two counter-profiles 4′ are provided on the pawl 7 itself, as well as two reinforcing profiles 4 formed in one piece with the inner ring 5. The freewheeling mechanism 10 of FIG. 3 consists by way of example of exactly two parts, specifically the one-piece inner ring 5 and the one-piece outer ring 3.

A fourth exemplary embodiment of a positive overrunning clutch 10 according to the invention is shown in FIGS. 4A and 4B. FIG. 4A shows by way of example the overrunning clutch 10 installed in a hammer drill 100, which is only partially shown here. FIG. 4B shows the exposed inner ring 5.

As in the exemplary embodiment in FIG. 3, the inner ring 5 of FIG. 4B has six pawls 7, which are arranged along an outer circumference UR of the inner ring 5. All of the pawls 7 are formed in one piece with the inner ring 5. Each of the pawls 7 has a number of engagement flanks 6, which allows a higher torque transmission to the inner ring 5, which is provided here by way of example as a plastic injection-molded part.

In addition to the overrunning clutch 10 shown in FIG. 3, the inner ring 5 of the overrunning clutch of FIGS. 4A and 4B has at least one secondary pawl 9 (in the exemplary embodiment shown there are six secondary pawls 9), which, with respect to an axis of rotation RA of the overrunning clutch 10, is/are arranged on the inner ring 5 offset in the axial direction AR relative to the pawl 7. The secondary pawls 9 are also formed in one piece with the inner ring 7. The pawl 7 and the secondary pawl 9 are in line in the axial direction AR. The freewheeling mechanism 10 of FIG. 4 consists by way of example of exactly three parts, specifically the one-piece inner ring 5, the one-piece outer ring 3 and the one-piece secondary outer ring 2.

As can be seen from FIGS. 4A and 4B, the pawls 7 and the secondary pawls 9 are spaced apart from one another by an axial gap 8 running around the inner ring 3 in the circumferential direction UR. Both the pawls 7 and the secondary pawls 9 are formed in each case as pressure pawls. Both the pawls 7 and the secondary pawls 9 have a number of engagement flanks 6, 6′, which allows a higher torque transmission to the inner ring 5, which is provided here by way of example as a plastic injection-molded part.

As already mentioned, FIG. 4A shows the overrunning clutch 10 installed in a hammer drill 100, which is partially shown. The hammer drill 100 is equipped with a tool fitting 20, an impact mechanism 30 and a rotary drive 40, which need not be explained in any more detail here. The overrunning clutch 10 in FIG. 4A has a secondary outer ring 2 arranged concentrically in relation to the inner ring 5. The secondary outer ring 2 is formed as a part different from the outer ring 3, so that by means of the secondary outer ring 2 a freewheeling function independent of the outer ring 3 is obtained. The outer ring 3 and the secondary outer ring 2 are arranged on one and the same inner ring 5.

The outer ring 3 has a swivel sleeve 11, with which the outer ring 3 is coupled by way of a connecting rod 35 to an impact mechanism 30 of the hammer drill 100 for the purpose of transferring movement.

### LIST OF REFERENCE SIGNS

1 Detent contour
2 Secondary outer ring
3 Outer ring
4 Reinforcing profile
4′ Counter-profile
5 Inner ring
5′ Pawl groove
6, 6′ Engagement flank
7 Pawl
7′ Compression spring
8 Axial gap
9 Secondary pawl
10 Overrunning clutch
11 Swivel sleeve
20 Tool fitting
30 Impact mechanism
35 Connecting rod
40 Rotary drive
100 Hammer drill
AR Axial direction
FR Freewheeling direction
RA Axis of rotation
RR Radial direction
SR Blocking direction
UR Circumferential direction

1-130 (canceled)

14. A positive overrunning clutch comprising:
an outer ring having a detent contour; and
an inner ring arranged concentrically in relation to the outer ring, the inner ring having a pawl provided for engagement in the detent contour,
the pawl being movably connected to the inner ring.

15. The overrunning clutch as recited in claim 14 wherein the pawl is formed in one piece with the inner ring.

16. The overrunning clutch as recited in claim 14 wherein the inner ring has a secondary pawl, the secondary pawl, based on an axis of rotation of the overrunning clutch, being arranged on the inner ring offset in an axial direction to the pawl.

17. The overrunning clutch as recited in claim 16 wherein the secondary pawl is formed in one piece with the inner ring.

18. The overrunning clutch as recited in claim 16 wherein the pawl and the secondary pawl are spaced from one another by a peripheral axial gap.

19. The overrunning clutch as recited in claim 16 wherein the pawl and the secondary pawl are formed in each case as a pressure pawl.

20. The overrunning clutch as recited in claim 16 wherein the pawl and the secondary pawl are in line in the axial direction.

21. The overrunning clutch as recited in claim 14 wherein the inner ring has a plurality of pawls arranged along an outer circumference of the inner ring.

22. The overrunning clutch as recited in claim 14 wherein the outer ring or the inner ring is provided as an injection-molded part.

23. The overrunning clutch as recited in claim 22 wherein the injection-molded part consists of plastic or is formed metal-free.

24. The overrunning clutch as recited in claim 14 wherein the inner ring has a reinforcing profile to increase a transmittable torque, the reinforcing profile being supported against a counter profile formed on the pawl when the overrunning clutch is actuated on the outer ring in the blocking direction.

25. The overrunning clutch as recited in claim 24 wherein the reinforcing profile or the counter profile is arranged on a side of the pawl facing away from the detent contour.

26. The overrunning clutch as recited in claim 14 wherein the overrunning clutch has a secondary outer ring arranged concentrically in relation to the inner ring, the secondary outer ring being formed as a part different from the outer ring and defining a freewheel independent of the outer ring.

27. The overrunning clutch as recited in claim 14 wherein the pawl has a plurality of engagement flanks.

28. The overrunning clutch as recited in claim 16 wherein the secondary pawl has a plurality of engagement flanks.

29. The overrunning clutch as recited in claim 14 wherein the outer ring has a swivel sleeve for coupling the outer ring to an impact mechanism or a rotary drive of a hammer drill.

30. A hammer drill comprising:
a tool fitting;
a impact mechanism;
a rotary drive; and
an overrunning clutch as recited in claim 14, the tool fitting being coupled to the impact mechanism or the rotary drive via the overrunning clutch for the purpose of transferring movement.
